(19) United States
(12) Patent Application Publication
(10) Pub. No.: US 2017/0193521 A1
(43) Pub. Date: Jul. 6, 2017

(54) PROACTIVE CUSTOMER RELATION MANAGEMENT PROCESS BASED ON APPLICATION OF BUSINESS ANALYTICS

(71) Applicant: International Business Machines Corporation, Armonk, NY (US)

(72) Inventors: Remeez Backer, Philadelphia, PA (US); Priyanka Jain, Downingtown, PA (US); Richard J. Parente, Jamison, PA (US); Maria Potalivo, Langhorne, PA (US)

(21) Appl. No.: 15/182,197

(22) Filed: Jun. 14, 2016

Related U.S. Application Data
(63) Continuation of application No. 14/987,164, filed on Jan. 4, 2016.

(51) Int. Cl. G06Q 30/00; G06Q 30/02

(52) U.S. Cl. CPC G06Q 30/016; G06Q 30/0201

(57) ABSTRACT

A method for a software vendor to proactively identify problems a customer may have with software procured from the software vendor includes: inputting into a data set customer data; constructing a customer-satisfaction mathematical model; applying a robustness analytic process to the model to determine a robustness value; determining if the robustness value meets or exceeds a robustness threshold value; applying a significance analytic process to quantitative customer-satisfaction attributes to determine a significance value in response to the robustness value of the mathematical model meeting or exceeding a robustness threshold value; sending a notification to a subject matter expert in response to the significance value being less than or equal to a significance threshold value and the quantified customer-satisfaction attributes express dissatisfaction with the software; receiving from the subject matter expert a remedial plan to improve the quantified customer-satisfaction attributes; and implementing the remedial plan by modifying the software.

This application is a continuation of U.S. application Ser. No. 14/987,164, entitled “PROACTIVE CUSTOMER RELATION MANAGEMENT PROCESS BASED ON APPLICATION OF BUSINESS ANALYTICS”, filed Jan. 4, 2016, which is incorporated herein by reference in its entirety.

### BACKGROUND

The present disclosure relates to customer relation management, and more specifically to proactively identifying customer software problems while they may still be minor in nature or not noticeable and eliminating the identified problems by fixing or modifying the software before the problems may rise to a more serious level.

### SUMMARY

According to an embodiment, a method for a software vendor to proactively identify problems a customer may have with software procured from the software vendor is disclosed. The method includes: inputting into a data set, by a processor, customer data having customer identifying data and customer-satisfaction data related to customer satisfaction with the software; constructing, by the processor, a mathematical model that is configured to model first quantitative customer-satisfaction attributes in the customer-satisfaction data; applying, by the processor, one or more robustness analytic processes to the mathematical model to determine a robustness value that quantifies robustness of the mathematical model; determining, by the processor, if the robustness value of the mathematical model meets or exceeds a robustness threshold value; applying, by the processor, one or more significance analytic processes to the modeled first quantitative customer-satisfaction attributes to determine a significance value that quantifies statistical significance of the quantified customer-satisfaction attributes in response to the robustness value of the mathematical model meeting or exceeding a robustness threshold value; sending, by the processor, a notification having the quantified customer-satisfaction attributes to a subject matter expert in response to the significance value being less than or equal to a significance threshold value and the quantified customer-satisfaction attributes express dissatisfaction with the software; receiving, by the processor, from the subject matter expert a remedial plan to improve the quantified customer-satisfaction attributes; and implementing, by the processor, the remedial plan by at least one of modifying the software to provide modified software, modifying a configuration of the software to provide a modified configuration, and modifying an implementation plan for implementing the software to provide a modified implementation plan.

According to an embodiment, a system for a software vendor proactively identifying problems a customer may have with software procured from the software vendor is disclosed. The system includes a memory having computer readable instructions and a processor for executing the computer readable instructions. The computer readable instructions include: inputting into a data set customer data having customer identifying data and customer-satisfaction data related to customer satisfaction with the software; constructing a mathematical model that is configured to model first quantitative customer-satisfaction attributes in the customer-satisfaction data; applying one or more robustness analytic processes to the mathematical model to determine a robustness value that quantifies robustness of the mathematical model; determining if the robustness value of the mathematical model meets or exceeds a robustness threshold value; applying one or more significance analytic processes to the modeled first quantitative customer-satisfaction attributes to determine a significance value that quantifies statistical significance of the quantified customer-satisfaction attributes in response to the robustness value of the mathematical model meeting or exceeding a robustness threshold value; sending a notification having the quantified customer-satisfaction attributes to a subject matter expert in response to the significance value meeting or exceeding a significance threshold value and the quantified customer-satisfaction attributes express dissatisfaction with the software; receiving from the subject matter expert a remedial plan to improve the quantified customer-satisfaction attributes; and implementing the remedial plan by at least one of modifying the software to provide modified software, modifying a configuration of the software to provide a modified configuration, and modifying an implementation plan for implementing the software to provide a modified implementation plan.

According to an embodiment, a computer program product for a software vendor proactively identifying problems a customer may have with software procured from the software vendor is disclosed. The computer program product includes a computer readable storage medium having program instructions embodied therewith. The program instructions executable by a processor to cause the processor to: input into a data set customer data having customer identifying data and customer-satisfaction data related to customer satisfaction with the software; construct a mathematical model that is configured to model first quantitative customer-satisfaction attributes in the customer-satisfaction data; apply one or more robustness analytic processes to the mathematical model to determine a robustness value that quantifies robustness of the mathematical model; determine if the robustness value of the mathematical model meets or exceeds a robustness threshold value; apply one or more significance analytic processes to the modeled first quantitative customer-satisfaction attributes to determine a significance value that quantifies statistical significance of the quantified customer-satisfaction attributes using the processor in response to the robustness value of the mathematical model meeting or exceeding a robustness threshold value; send a notification having the quantified customer-satisfaction attributes to a subject matter expert in response to the significance value being less than or equal to a significance threshold value and the quantified customer-satisfaction attributes express dissatisfaction with the software; receive from the subject matter expert a remedial plan to improve the quantified customer-satisfaction attributes; and implement the remedial plan by at least one of modifying the software to provide modified software, modifying a configuration of the software to provide a modified configuration, and modifying an implementation plan for implementing the software to provide a modified implementation plan.

### BRIEF DESCRIPTION OF THE DRAWINGS

FIG. 1 illustrates a computer system according to an embodiment;

FIG. 2A-2C, collectively referred to as FIG. 2, is a flow chart for a method for proactively identifying problems a customer may have with software in accordance with an embodiment;

FIGS. 3A-3J, collectively referred to as FIG. 3, depict aspects of an interview form for interviewing software customers in accordance with an embodiment;

FIG. 4 depicts aspects of a decision tree in accordance with an embodiment;

FIG. 5 is a flow chart for implementing robustness analytic processes and significance analytic processes in accordance with an embodiment;

FIG. 6 is another flow chart for implementing robustness analytic processes and significance analytic processes in accordance with an embodiment;

FIG. 7 depicts a cloud computing environment according to an embodiment in accordance with an embodiment; and

FIG. 8 depicts abstraction model layers according to an embodiment.

### DETAILED DESCRIPTION

Embodiments described herein are directed to systems and methods for proactively identifying problems a customer may be having with software and taking actions to eliminate the problems by fixing or modifying the software so that customer satisfaction may be increased. By increasing customer satisfaction, the likelihood of the customer remaining a customer is increased. Because resources for correcting software problems may be limited, the system and method may prioritize the identified problems so that the resources are applied to those problems which if immediately corrected provide the most benefit to both the customer and software vendor.

A computer system/server 12 for implementing methods disclosed herein is now discussed with reference to FIG. 1. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. Magnetic disk drives and optical disk drives are non-limiting examples of a software writing device. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

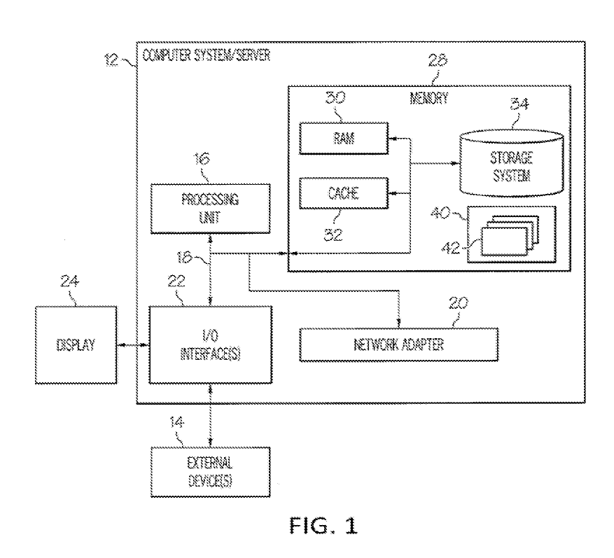

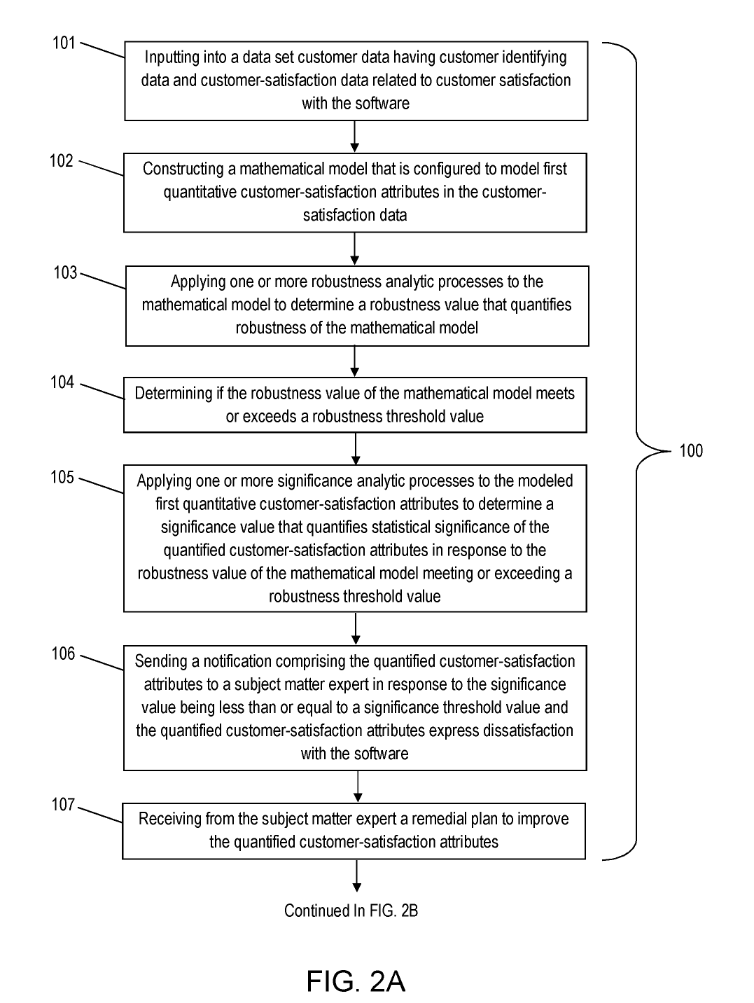

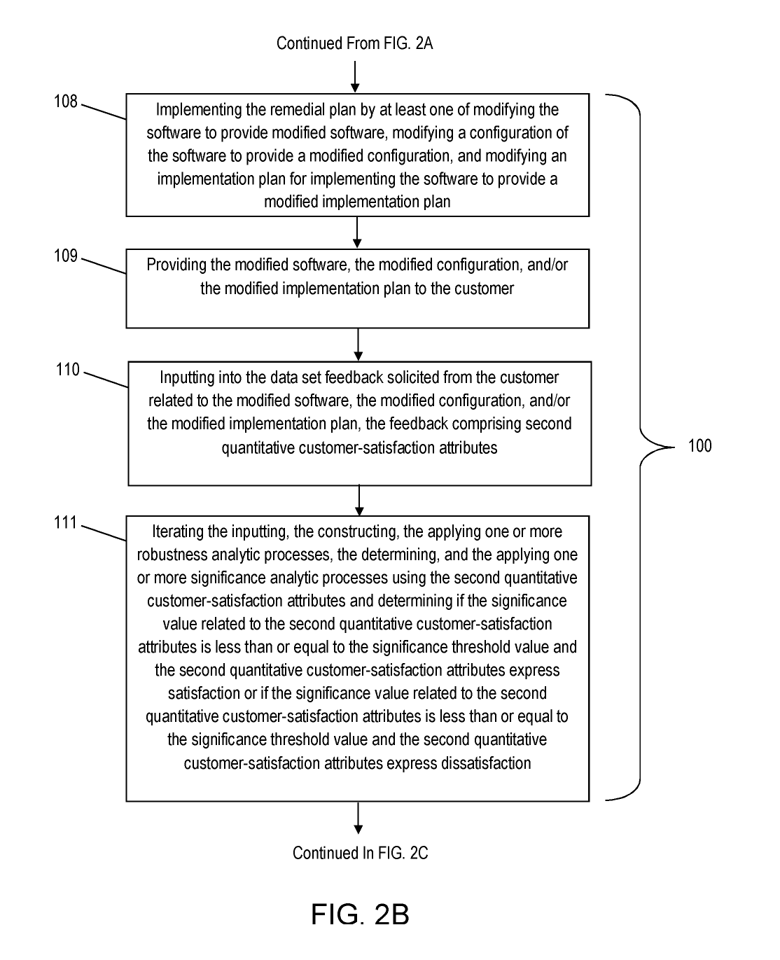

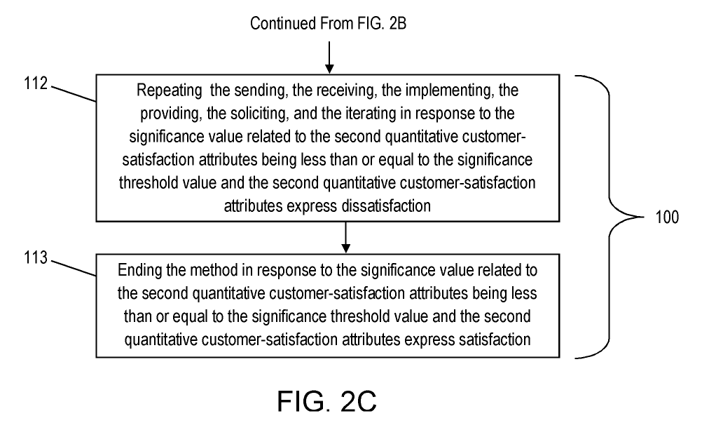

FIG. 2 is a flow chart for a method 100 for a software vendor proactively identifying problems a customer may have with software procured from the software vendor. The processing shown in FIG. 2 can be performed using the computer system/server 12 depicted in FIG. 1. The term “problems” may include software code that does not work as expected or provide a desired result. The problems may be present on-going problems or potential problems that may be apparent going forward in the future. Block 101 calls for inputting into a data set, by a processor, customer data having customer identifying data and customer-satisfaction data related to customer satisfaction with the software. The term “software” as used herein is inclusive of such software areas or solutions as (1) a process that software is implementing for customer, (2) an implementation process for implementing the software and (3) a configuration of the software used for the customer's application. The known customer data can include customer contact information for as many contacts as possible from each customer in a plurality of customers, along with descriptive details about the company of the customer and its purchase history. Customer contact information can include, but is not limited to: first name, last name, title, title category (technical, business manager, or executive), department, phone number, email address, length of employment at the company, geographical location, primary language, manager's name and title, and any alternate phone numbers or email addresses. The company information can include, but is not limited to: company name, geographical location, Industry, how long they have been a client, which products they own, which product versions they are currently using, databases, platforms, operating systems, parent company name, software vendor revenue from company, the status of each project (planning, installing, implementing/testing, in production), and contact information for any sales representatives assigned to the client. Block 101 may also include cleaning and preprocess data. This involves making sure that the data obtained is in a usable condition, removing all obvious outliers, making sure all the values are in a reasonable range, making sure that there is a consistency in the units of measurement and definition of fields and finally figuring out how missing data should be handled. In one or more embodiments, missing data can be interpolated from existing data or it can be obtained by conducting another interview with the customer as appropriate.

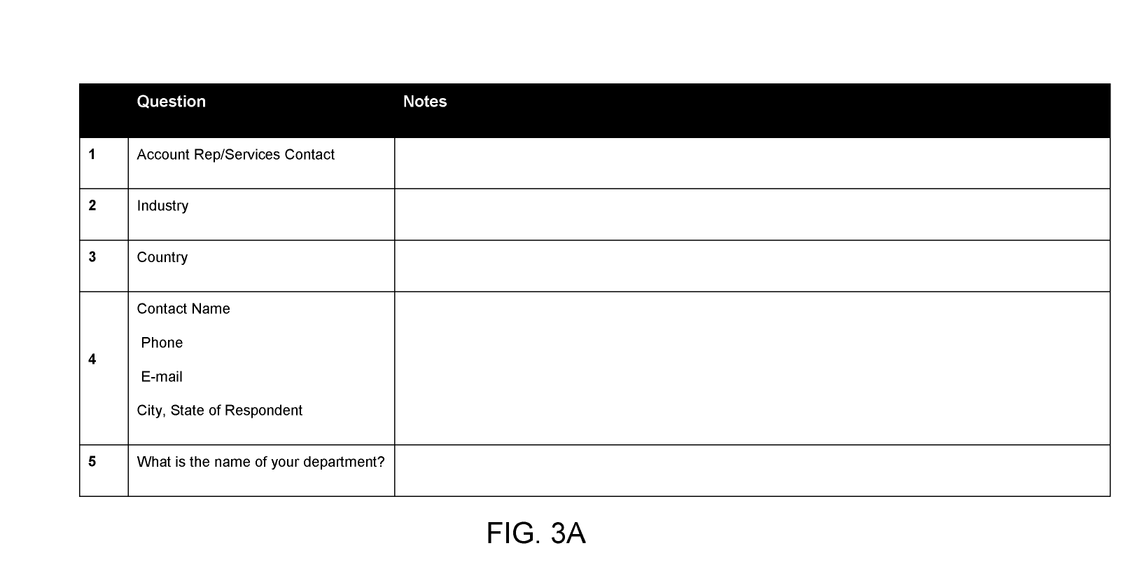

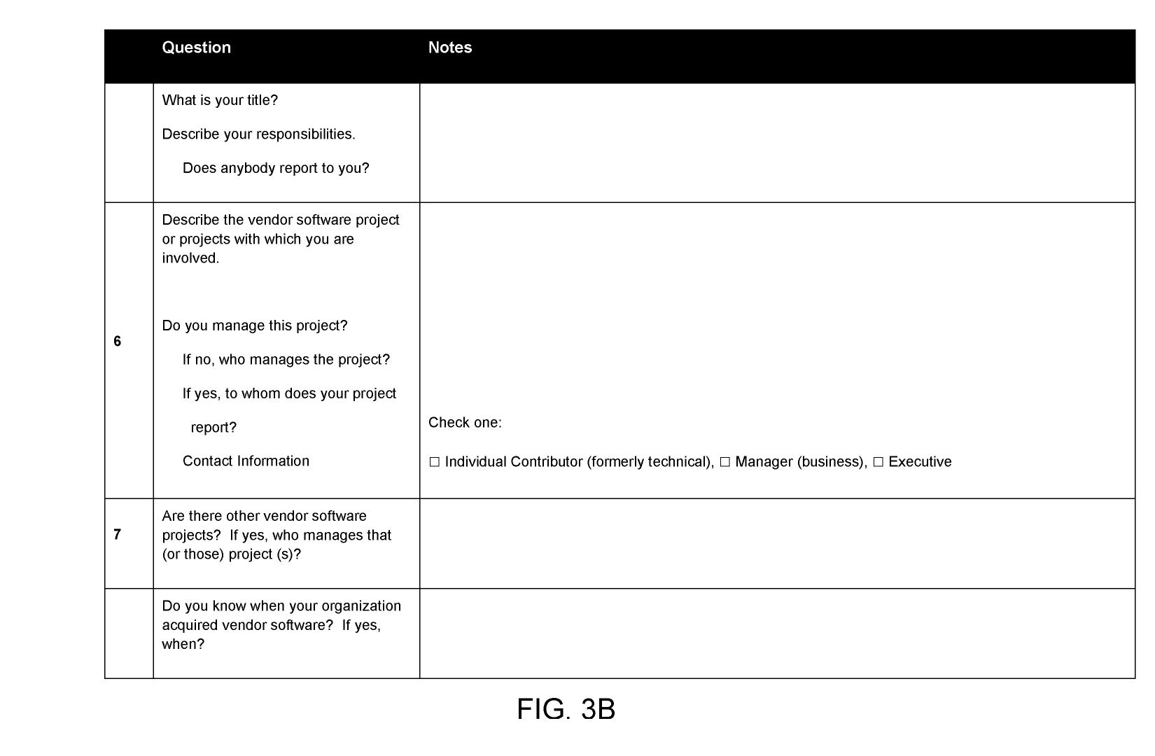

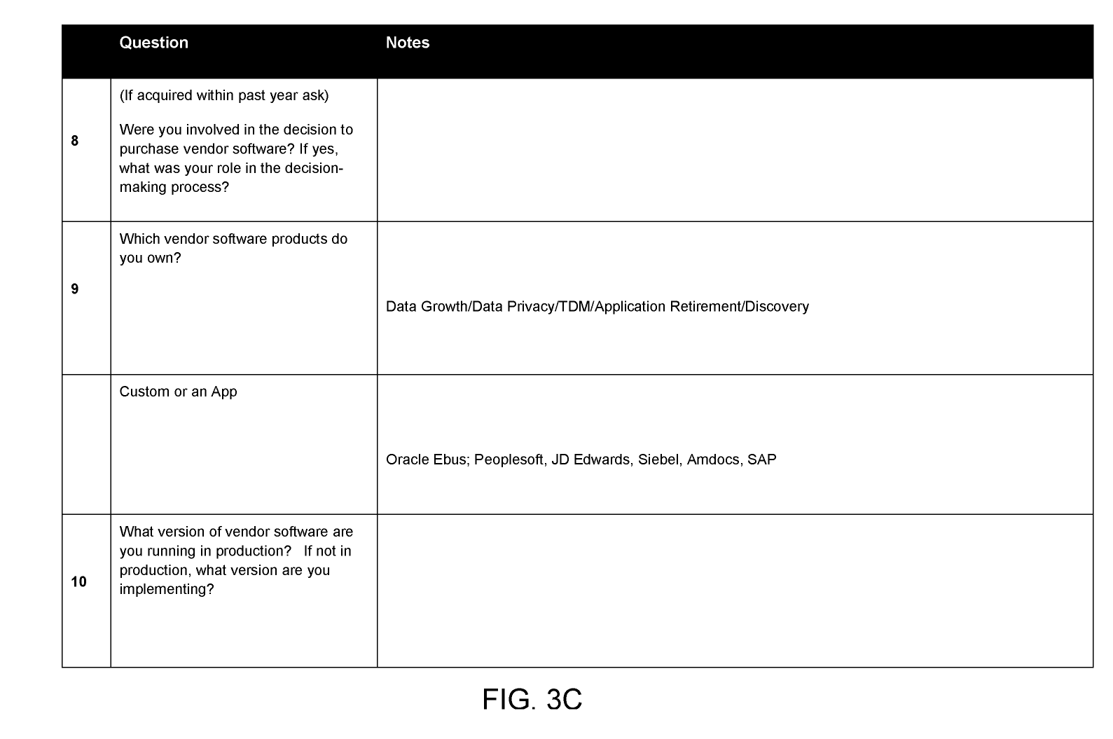

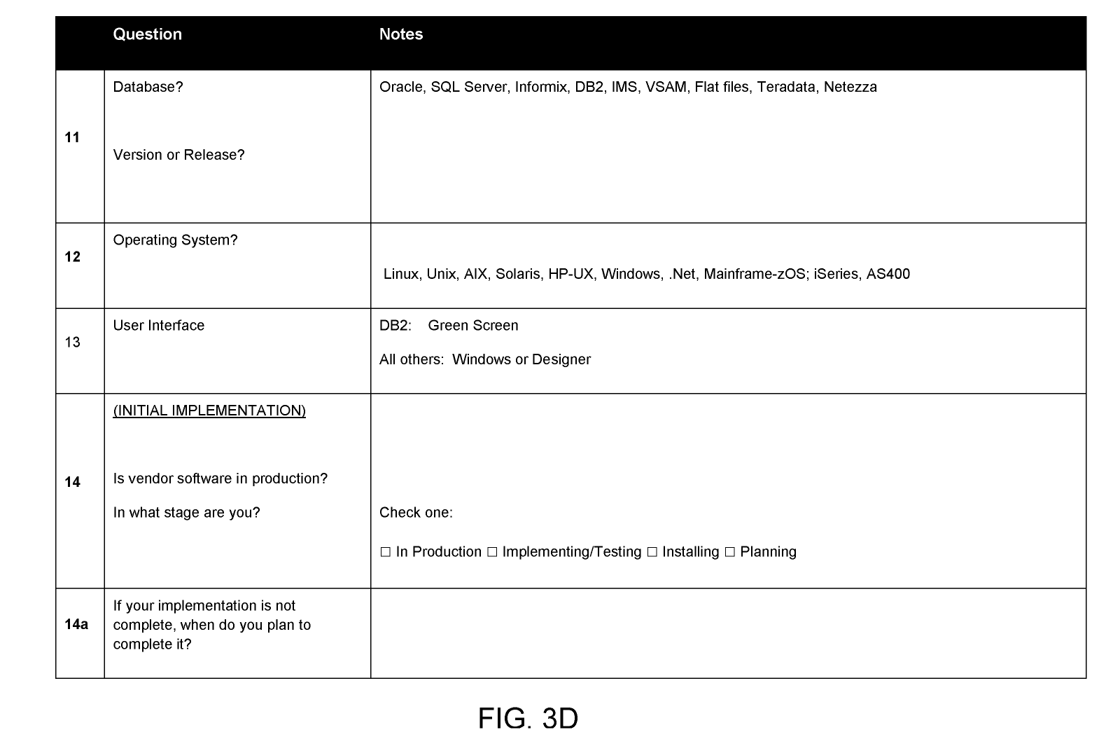

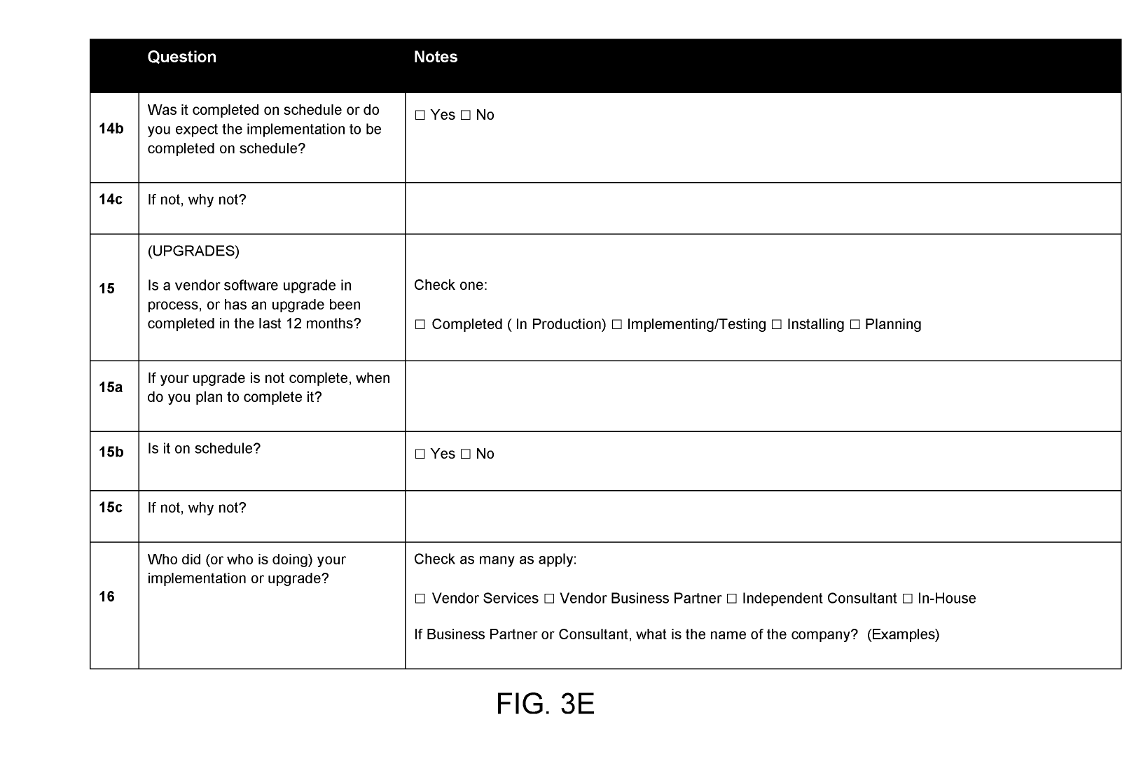

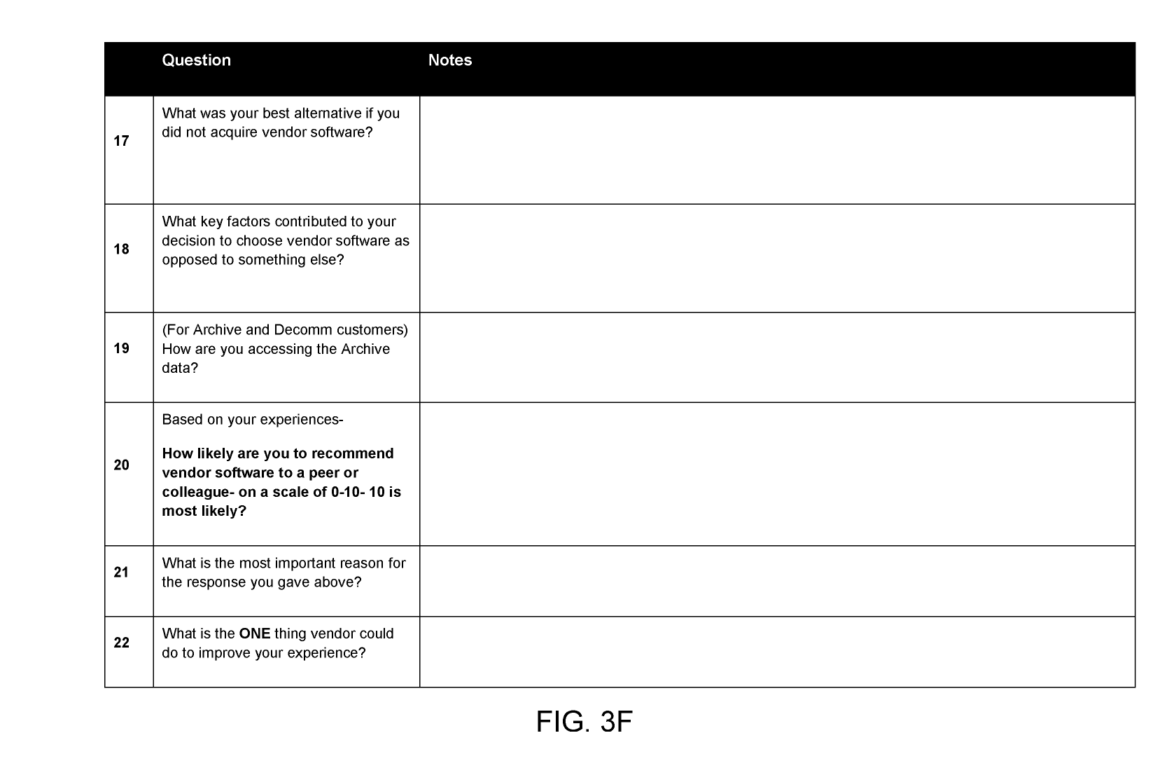

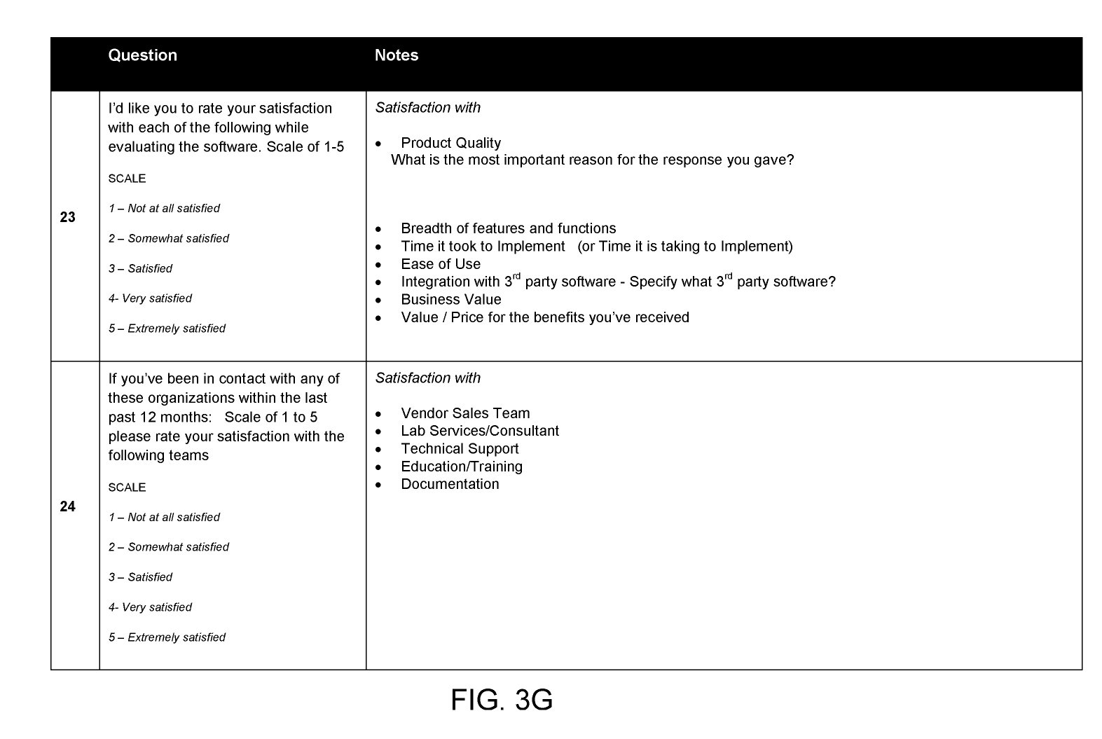

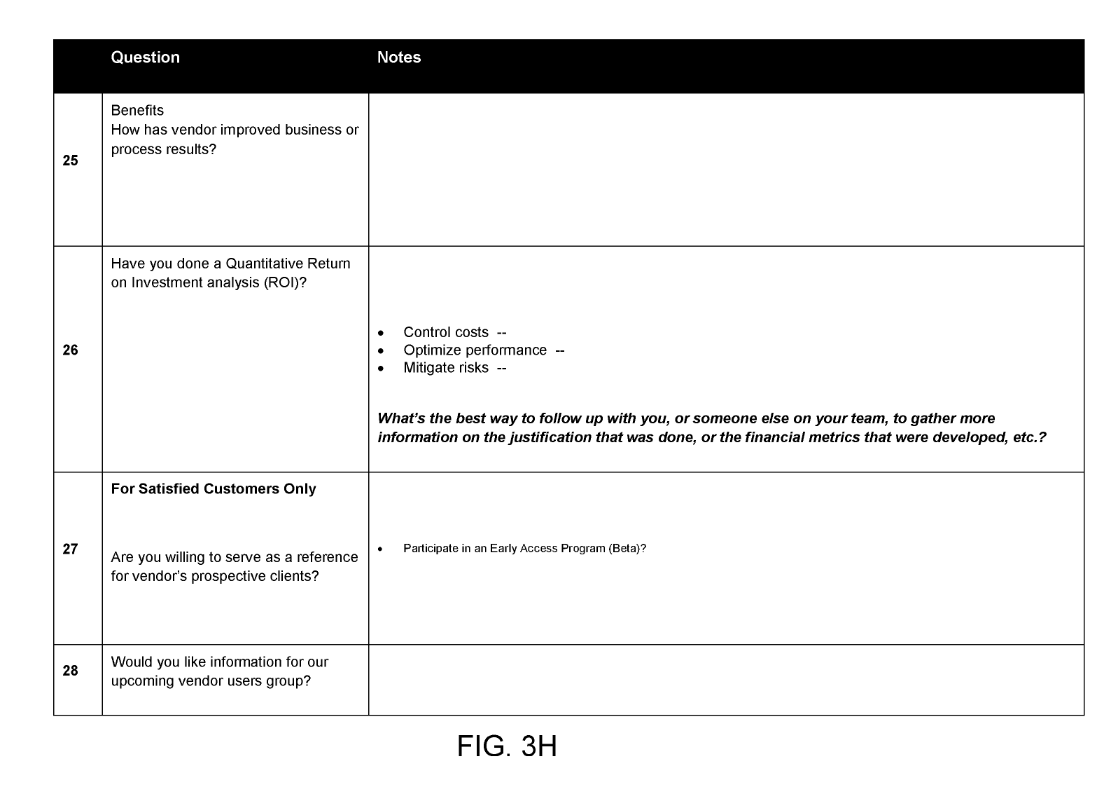

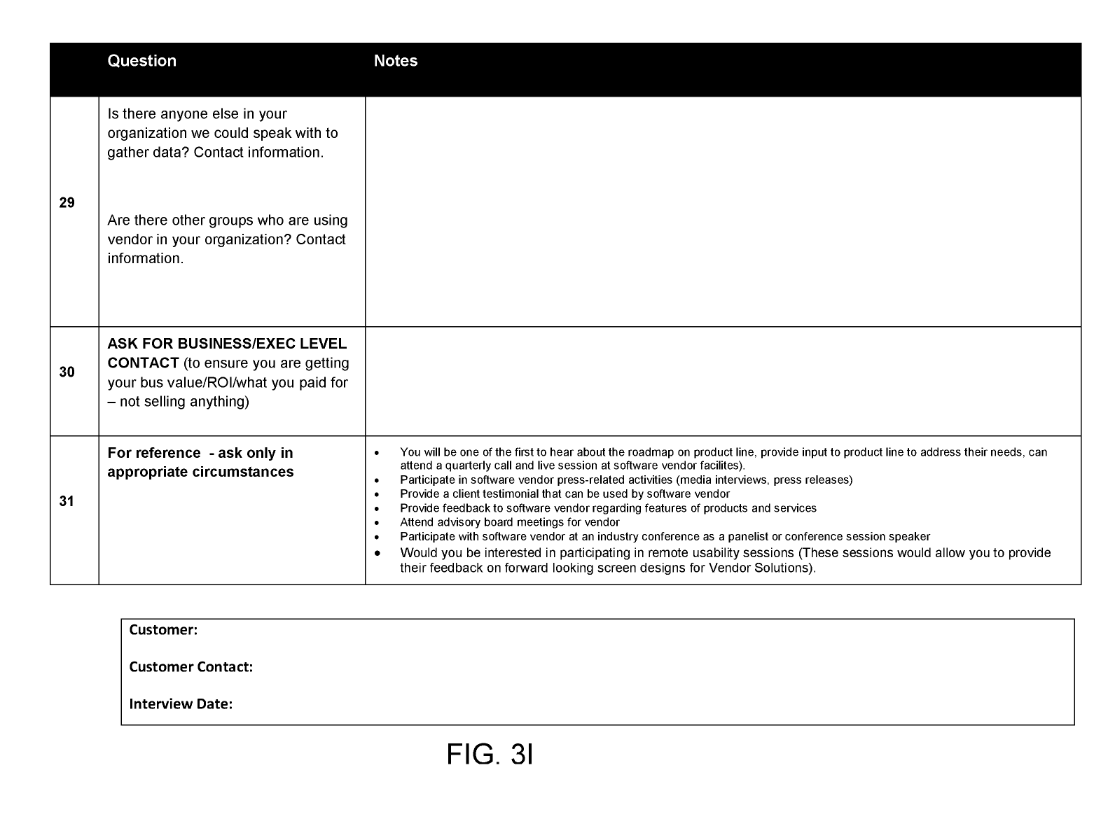

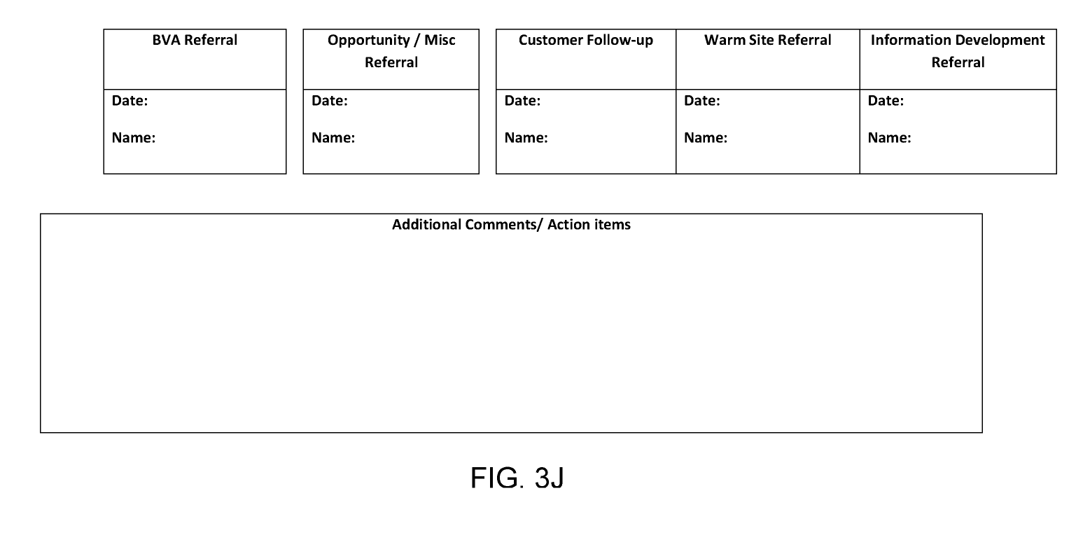

In one or more embodiments, the newly acquired customer satisfaction data is acquired using interviews with customers. FIG. 3 illustrates an example of an interview form used to interview customers to determine their satisfaction with the software. FIGS. 3A-3J together in series illustrate the complete interview form. In one or more embodiments, the interview form may include multiple questions related to each other such as asking similar questions in order to validate the customer's response. The results of the customer interview are a plurality of satisfaction attributes each of which may be quantified by numeric values. The plurality of satisfaction attributes is associated with or tied to the known customer data. Other methods of obtaining the customer satisfaction, such as on-line or mailed surveys, may also be used.

In one example of obtaining customer satisfaction data, the goal is to contact all clients (i.e., customers) and schedule a 15-20 minute phone interview, during which the interviewee is asked a structured set of interview questions including specific satisfaction variable questions, as well as open-ended questions. The interview includes a question based on the Net Promoter System in order to collect the contacts' Recommend Score, categorize them into a Recommend Score Category (e.g., Promoter, Passive, or Detractor), and calculate an overall Net Promoter Score (NPS) from all interviewees. The Net Promoter System, which helps companies achieve sales growth through customer and employee loyalty, was created by Fred Reichheld, a Bain Fellow and founder of Bain & Company's Loyalty Practice. The NPS question is “On a scale of 0-10, how likely is it that you would recommend [company/product name] to a friend or colleague?” Based on the answer given, the interviewee is categorized as a Promoter (score 9-10), a Passive (score 7-8), or a Detractor (score 0-6). The NPS is calculated by taking the percentage of customers who are Promoters and subtracting the percentage who are Detractors. Other interview methodologies may also be used.

Referring to FIG. 2, block 102 of the method 100 calls for constructing, by the processor, a mathematical model that is configured to model first quantitative customer-satisfaction attributes in the customer-satisfaction data. In one or more embodiments, the mathematical model may be an arbitrary equation that models the numeric values of the quantified answers to the interview questions. Block 103 calls for applying, by the processor, one or more robustness analytic processes to the mathematical model to determine a robustness value that quantifies robustness of the mathematical model. Non-limiting embodiments of various robustness analytic processes are discussed in detail further below. Block 104 calls for determining, by the processor, if the robustness value of the mathematical model meets or exceeds a robustness threshold value. In one or more embodiments, a 0-100% scale is used to quantify the robustness value with 100% indicating a 100% correspondence of the mathematical model to the first quantitative customer-satisfaction attributes or, said in other words, the model may provide a satisfaction attribute value that is the same at the corresponding true attribute value. A 50% robustness value may indicate that the model may provide a satisfaction attribute value that is within 50% of the corresponding true satisfaction attribute value. A 25% robustness value may indicate that the model may provide a satisfaction attribute value that is within 75% of the corresponding true satisfaction attribute value.

Block 105 calls for applying, by the processor, one or more significance analytic processes to the modeled first quantitative customer-satisfaction attributes to determine a significance value that quantifies statistical significance of the quantified customer-satisfaction attributes in response to the robustness value of the mathematical model meeting or exceeding a robustness threshold value. Non-limiting embodiments of various significance analytic processes are discussed in detail further below.

Block 106 calls for sending, by the processor, a notification comprising the quantified customer-satisfaction attributes to a subject matter expert in response to the significance value being less than or equal to a significance threshold value and the quantified customer-satisfaction attributes express dissatisfaction with the software. In one or more embodiments, the significance threshold value is 0.05 where lower values indicate increased significance. In one or more embodiments, the subject matter expert is implemented by an expert system that emulates the decision-making ability of a human expert. The expert system may be implemented by a computer processing system such as the computer system/server 12. The expert system may be divided into two subsystems: an inference engine and a knowledge base that represents known facts and rules. The inference engine is configured to apply the rules to the known facts to deduce new facts. Block 107 calls for receiving, by the processor, from the subject matter expert a remedial plan to improve the quantified customer-satisfaction attributes. Block 108 calls for implementing, by the processor, the remedial plan by implementing at least one selection from the group consisting of modifying the software to provide modified software, modifying a configuration of the software to provide a modified configuration, and modifying an implementation plan for implementing the software to provide a modified implementation plan. The remedial plan may address current on-going problems and/or potential problems. Block 109 calls for providing, by the processor, the modified software, the modified configuration, and/or the modified implementation plan to the customer.

Block 110 calls for inputting, by the processor, into the data set feedback solicited from the customer related to the modified software, the modified configuration, and/or the modified implementation plan, the feedback comprising second quantitative customer-satisfaction attributes. In one or more embodiments, customer feedback may be solicited by an interview such as by a telephone interview or a mailed interview form for example.

Block 111 calls for iterating, by the processor, the inputting, the constructing, the applying one or more robustness analytic processes, the determining, and the applying one or more significance analytic processes using the second quantitative customer-satisfaction attributes and determining if the significance value related to the second quantitative customer-satisfaction attributes is less than or equal to the significance threshold value and the second quantitative customer-satisfaction attributes express satisfaction or if the significance value related to the second quantitative customer-satisfaction attributes is less than or equal to the significance threshold value and the second quantitative customer-satisfaction attributes express dissatisfaction.

Block 112 calls for repeating, by the processor, the sending, the receiving, the implementing, the providing, the soliciting, and the iterating in response to the significance value related to the second quantitative customer-satisfaction attributes being less than or equal to the significance threshold value and the second quantitative customer-satisfaction attributes express dissatisfaction.

Block 113 calls for ending, by the processor, the method in response to the significance value related to the second quantitative customer-satisfaction attributes being less than or equal to the significance threshold value and the second quantitative customer-satisfaction attributes express satisfaction. This block may include proactively stopping any remedial plan or portion of remedial plan from being implemented further. Block 113 may also include sending a notification that the second quantitative customer-satisfaction attributes express satisfaction using the processor. The notification in this block may be sent to the data set for entry and/or a user.

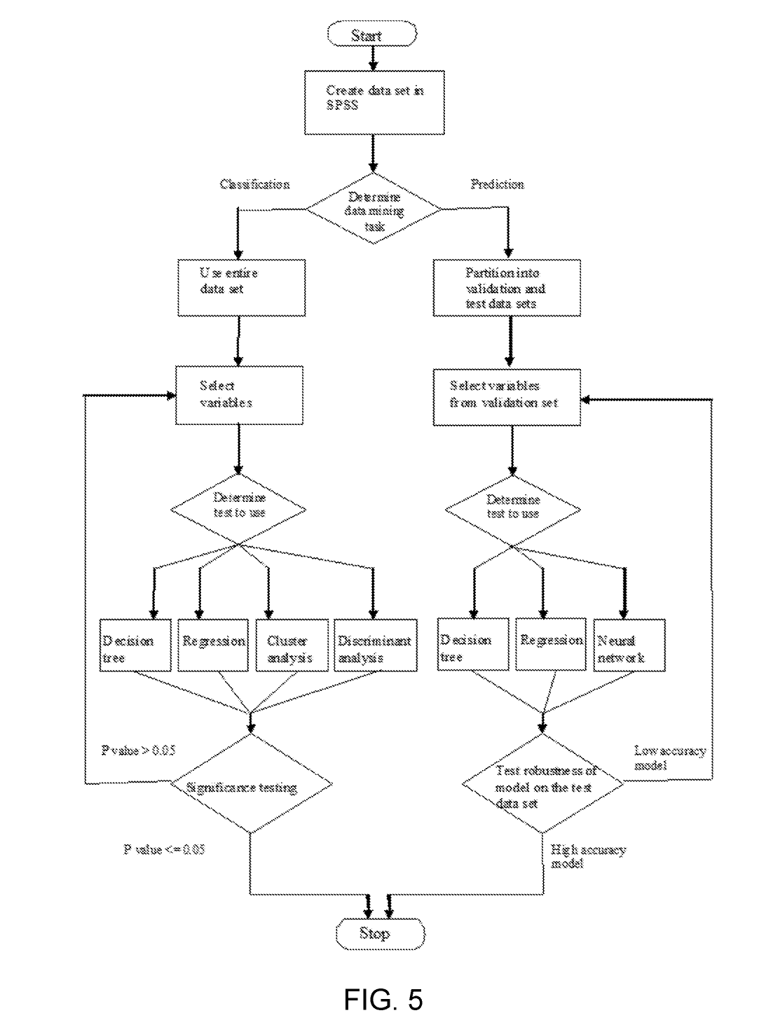

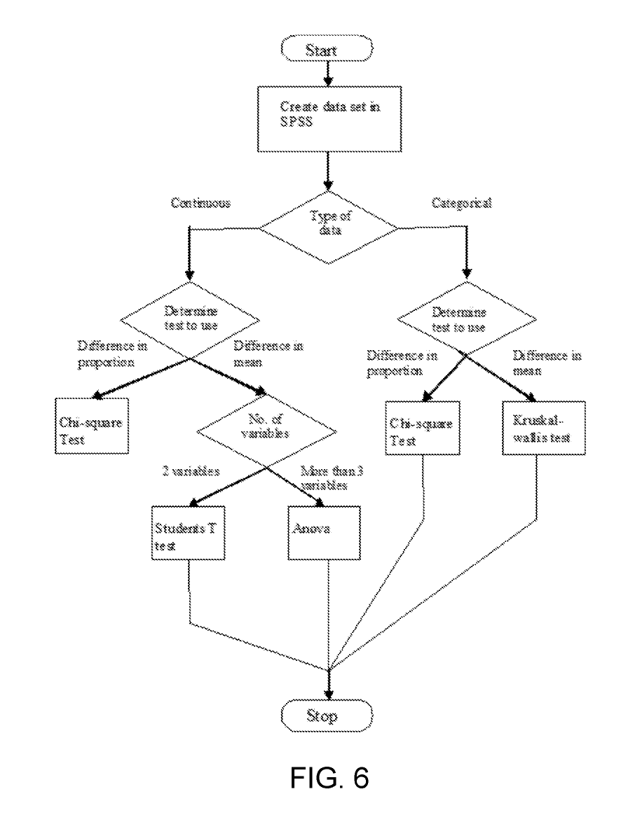

FIGS. 5 and 6 present flow charts of embodiments for applying the robustness analytic processes and the significance analytic processes. In both flow charts, the “Stop” block represents determining if the customer-satisfaction data related to customer satisfaction with the software is statistically significant or not and presenting the results to a user and/or entering the results in the data set. FIG. 5 illustrates two vertical tracks of blocks, one on the left and one on the right. In one or more embodiments, the blocks in the right track are performed first in order to construct a mathematical model that is configured to model quantitative customer-satisfaction attributes in the customer-satisfaction data with a desired level of robustness. The quantitative customer-satisfaction attributes may measure customer satisfaction with software procured from a software vendor or dissatisfaction. The right track includes partitioning the data set into a validation data set and a test data set that are used to construct the model. Variables are then selected from the validation data set for testing. Next, one or more tests are selected to be applied to the validation data set. Next, the tests are applied to the validation data set. Next, a robustness value is determined that quantifies robustness of the mathematical model. If the robustness value is less than a robustness threshold value, then the model is modified such as by changing values in the model and the testing repeated. If the robustness value exceeds a robustness threshold value, then the mathematical model is used in the left track for applying one or more significance analytic processes to the modeled quantitative customer-satisfaction attributes to determine a significance value that quantifies statistical significance of the quantified customer-satisfaction attributes. In the left track, the entire data set may be used. From the entire data, variables that represent the quantified customer-satisfaction attributes are tested using one or more tests. From the tests, a significance value is determined. If the significance value is greater than a threshold significance value (e.g., 0.05) then the variables that represent the quantified customer-satisfaction attributes are changed and the tests repeated. If the significance value is less than the threshold significance value, then the quantified customer-satisfaction attributes are considered to be significant and further action is taken to correct or modify software for the software customer. FIG. 6 is a flow chart providing more detail for implementing the testing in either the left or right tracks. In FIG. 6, “Continuous” represents continuous variables (e.g., a numeric quantity) and “Categorical” represents non-continuous variables (e.g., on or off). Continuous variables are processed the left vertical track in FIG. 6, while categorical variable are processed using the right vertical track.

Next, various analytic processes are presented as non-limiting embodiments for implementing the robustness analytic processes and the significance analytic processes.

Multiple linear regression (MLR) models can be used to develop a model that predicts a numerical variable based on the values of supplementary variables. The variable that is being predicted is called the dependent variable and the additional variables used to create the model are called independent variables. Additionally, MLR can be used to determine the type of relationship that exists between the dependent and independent variables. MLR is used in general to either to classify or predict continuous variables and as such variations of this model called, binary logistic regression and ordinal regression are used for the data modeling because of the non-continuous nature of some of the data. “Linear regression is used to fit a linear relationship between a quantitative dependent variable Y and a set of predictors X₁, X₂, X₃ . . . . Xₙ (Independent variables)”. The formula for MLR is as follows Y=β₀+β₁X₁+β₂X₂+ . . . +βₙXₙ+ε where Y=Dependent Variable X₁, X₂, Xₙ=Independent variables β0 . . . βn=Coefficients ε=Noise. The coefficients are estimated from the data by a method called Ordinary Least Squared (OLS). This method minimizes the sum of the squared vertical distances between the observed value of the dependent variable and the value predicted by the model. MLR makes the following assumptions. The dependent variable is normally distributed; a linear relationship exists between the dependent and independent variables; all the cases are independent of each other; and the variance in dependent variable is same regardless of the values of the independent variables (homoskedasticity).

Binary logistic regression is an extension of MLR where the dependent variable is dichotomous or binary in nature. Logistic regression is used to classify an observation with an unknown class, into one of the classes based on the values of the predictor variables. Logistic regression models are used to gain a better understanding of the reference-ability of the software. Reference-ability is a binary variable where a reference is coded as a 1 and a non-reference is coded in as 0. Since this is an exploratory model the performance of the model is based on how closely the model fits the data, therefore the entire available data is used instead of splitting the dataset into separate training and validation sets.

Methodology: The theory behind logistic regression is as follows, since the dependent variable can only take the values between 0 and 1 the formula used to calculate MLR cannot be directly used because there is no guarantee that the result will be between 0 and 1. So instead a function of the dependent variable called the logit is used. The logit is used to make a linear function of the predictors and map it back to the probability Y. The logistic regression model is as follows Log(odds)=β₀+β₁X₁+β₂X₂ + . . . +βₙXₙ where, Odds=P/(1−P) and P=the probability of belonging to class1 Log(Odds) is called the Logit and can take any value between −∞ to ∞. The model uses the logit as the dependent variable and maps it as a linear function of the independent variables. Once the value of the logit is obtained, the probability of getting a 1 on the dependent variable (p) by using the formula p=odds/(1+odds) can be obtained. Creating the model: In this step, the best possible model from the available data is obtained. This involves testing out different models with different predictors. The first step of this process is to reduce the number of variables that have to be tested for since there are a large number of variables that can be used as a predictor for the dependent variable. Correlation analysis between the variable of interest and the different possible predictor variables is used. By analyzing the correlation matrix, redundancy can be reduced and the accuracy of the predictions improved. Predictors that have low levels of correlation with the output variable can be eliminated. Also, multicollinearity between the different independent variables can be tested for. Multicollinearity means there is a high degree of correlation between two variables, if it exists between independent variables, it skews the end result. Correlation matrices and scatterplots are used to estimate the correlation between the variables. Once the variables that are correlated are identified, there are two methods to deal with the situation. One is to simply drop one of the correlated variables. The second one would be to create a composite variable that accounts for the variation in multiple variables. This method is called principle component analysis (PCA). In PCA the input variables are analyzed and the weighted linear combinations of the original variables are created that provides the explanatory power of the entire original set, this might not necessarily increase the efficiency of the model.

Model Example: The following model is used to classify references and find out which variables are the best predictors of reference-ability. In an embodiment, the variables selected to be used in the model are Recommend Score, Satisfaction with Product Quality and Satisfaction with Time to Implement. The variables in this model can be selected by trial and error in order to get the best model.

TABLE 1
Case Processing Summary

| | | |
|---|---|---|
| Unweighted Cases^{a} | N | Percent |

| | | | |
|---|---|---|---|
| Selected Cases | Included in | 692 | 61.9 |
| | Analysis | | |
| | Missing Cases | 426 | 38.1 |
| | Total | 1118 | 100.0 |

| | | |
|---|---|---|
| Unselected Cases | 0 | .0 |
| Total | 1118 | 100.0 |

^{a}If weighting is in effect, see classification table for the total number of cases to provide weighting factor.

Table 1 is the case summary table that shows how many cases were selected for the analysis from the total sample. Respondents who have not given a value for all the dependent variables are excluded from the analysis, it can be seen in this particular model 426 people were excluded.

TABLE 2
Model Summary

| | −2 Log | Cox & Snell R | Nagelkerke R |
|---|---|---|---|
| Step | likelihood | Square | Square |
| 1 | 702.000^{a} | .303 | .405 |

^{a}Estimation terminated at iteration number 5 because parameter estimates changed by less than .001.

Model Summary (Table 2) table shows the fit of the model. A measure called the Nagelkerke, which is a pseudo R square value, is used to estimate the robustness of the model itself. It can be seen that the Nagelkerke is 0.405 which shows the robustness of the model.

TABLE 3
Classification Table^{a}

| | | | Predicted | | |
|---|---|---|---|---|---|
| | | | Reference | | |
| | | | Not a | | Percentage |
| | Observed | | Reference | Reference | Correct |
| Step 1 | Reference | Not a | 313 | 70 | 81.7 |
| | | Reference | | | |
| | | Reference | 107 | 202 | 65.4 |

| | |
|---|---|
| Overall Percentage | 74.4 |

^{a}The cut value is .500

Table 3 is one example of a classification table and shows how the model predicted the references. It can be seen that the model correctly predicted 313 out of 383 non-references and 202 out of 309 references.

TABLE 4
Variables in the Equation

| | | B | S.E. | Wald | df | Sig. | Exp(B) |
|---|---|---|---|---|---|---|---|
| Step 1^{a} | RecScore | .689 | .080 | 73.372 | 1 | .000 | 1.992 |
| | PQ_s | .630 | .166 | 14.462 | 1 | .000 | 1.878 |
| | IMP_s | .269 | .098 | 7.533 | 1 | .006 | 1.309 |
| | Constant | −9.124 | .802 | 129.399 | 1 | .000 | .000 |

^{a}Variable(s) entered on step 1: RecScore, PQ_s, IMP_s.

Variables table (Table 4) shows the significance value and the β coefficients of all the different dependent variables. In this case all the variables are significant. Evaluating Results: Once the number of predictors is reduced, multiple different models can be created with different sets of predictors to create a robust model. Since this is an exploratory model, significance testing along with confidence intervals are used to identify whether the selected predictors have statistical significant impact on the final model. Analogues Tests: Culture Analysis Discriminant Analysis.

Ordinal Regression: Most of the variables that are of interest are ordinal in nature. Ordinal values are categorical data where you can rank the values in ascending order but there is no consistent difference or distance between the different values. For example satisfaction variables are valued from extremely unsatisfied to extremely satisfied, survey respondents give any value from 1 to 5. There is an incremental value but the distance between unsatisfied and neutral and neutral and satisfied are unknown. If a multiple linear regression model is used, it treats these variables as continuous and a logistic variable does not differentiate the incremental nature of the values. The ordinal regression model is an extension of the general model to fit ordinal data. Ordinal regression model is a modified version of the binary logistic regression model; it incorporates the ordinal data by defining the probabilities in a different manner. Instead of considering the probability of an individual event, the probability of the event itself and the probabilities of all the events that precede it are considered. Defining probabilities: θ₁=probability (value of 1)/Probability (value greater than 1) θ₂=probability (value of 1 or 2)/Probability (value greater than 2) θ₃=probability (value of 1, 2 or 3)/Probability (value greater than 3) The last category will not have any odds associated with it since the probability of scoring 1, 2 or 3 is 1 since they contain all the different values. The other categories can be summarized as follows θ₀=probability (value<=j)/Probability (value>j) Or θⱼ=probability (value<=j)/(1−Probability (value<=j)) The ordinal logistic model can be summarized as Ln(θ₀)=αⱼ−Bx Where j goes from 1 to the number of categories minus 1.

Model Example: The following model is used to classify the category of recommend score. The variables selected to be used in the model are Satisfaction with Product Quality, Satisfaction with Breadth of Features and Satisfaction with Time to Implement. The variables in this model are selected by trial and error in order to get the best model.

TABLE 5
Case Processing Summary

| | | | Marginal |
|---|---|---|---|
| | | N | Percentage |
| CATEGORY of | Detractor | 128 | 20.1% |
| RecScore: Detractor, | Passive | 308 | 48.4% |
| Passive, or Promoter | Promoter | 200 | 31.4% |
| Valid | | 636 | 100.0% |
| Missing | | 482 | |
| Total | | 1118 | |

Case processing Summary (Table 5) shows the frequency in all the different categories and the number of selected case.

TABLE 6
Pseudo R-Square

| | |
|---|---|
| Cox and Snell | .347 |
| Nagelkerke | .396 |
| McFadden | .205 |

Link function: Logit

Pseudo R-square table (Table 6) is used to show the robustness of the model.

TABLE 7
Parameter Estimates

| | | | | | | | 95% Confidence Interval | |
|---|---|---|---|---|---|---|---|---|
| | | | Std. | | | | Lower | Upper |
| | | Estimate | Error | Wald | df | Sig. | Bound | Bound |
| Threshold | [RecScoreCategory = 1] | 6.331 | .567 | 124.662 | 1 | .000 | 5.220 | 7.442 |
| | [RecScoreCategory = 2] | 9.341 | .641 | 212.570 | 1 | .000 | 8.085 | 10.596 |
| | PQ_s | 1.054 | .141 | 55.763 | 1 | .000 | .777 | 1.330 |
| Location | BF_s | .623 | .130 | 23.067 | 1 | .000 | .369 | .877 |
| | IMP_s | .471 | .085 | 30.930 | 1 | .000 | .305 | .637 |

Link function: Logit.
Parameter estimates show the β value and the significance of all the different dependent variables. Alternative tests may include multiple linear regression or logistic regression.

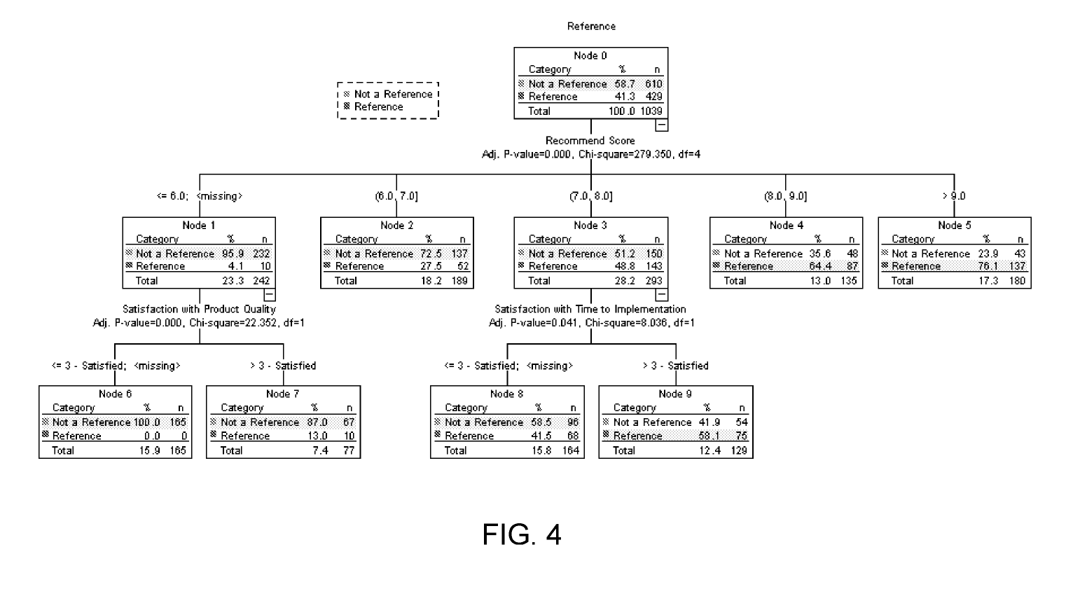

Decision trees can be used for both classification and prediction. A decision tree creates a classification table by recursively partitioning the predictor variable. For example, decision trees may be used to classify the references based on all the possible predictor variables. The model creates non-overlapping partitions of the dependent variables using the independent variable as separators. The divisions continue in a recursive fashion, meaning that the second level spilt will be operating on the results of the first level split. The model tries to divide up the dependent variable which is categorical into homogeneous sections. There are a couple of measures to determine homogeneity; two popular methods are Gini index and the entropy measure. The Geni impurity index for a partition “A” is defined by I(A)=1Σ(Pₖ)² Where Pₖ is defined as the proportion of observations in partition A that belongs to the category k of the dependent variable. The Geni index takes a value 0 if all the observations fall into a particular category and a value of (m−1)/m if all the categories of the dependent variable are equally represented. Entropy of A is calculated as Entropy(A)=−ΣPₖ log₂ (Pₖ)² This measure ranges from 0 where the classification is completely homogeneous and log₂(m) when all the categories are equally represented. The classification tree algorithm uses the measures of homogeneity to create pure separations of the dependent variable using recursive partitioning. Each successive partition will be more homogeneous than the level before. Predictive analytic software, such as SPSS® available from IBM Corporation, may be used to create a classification tree. Reference-ability as the dependent variable is used along with all the possible predictors of reference-ability as the predictor variables. In this example, recommend score, satisfaction with product quality, satisfaction with breadth of features, satisfaction with time to implement, satisfaction with ease of use, satisfaction with tech support, satisfaction with lab services, satisfaction with education and training and satisfaction with documentation are used. SPSS® uses the homogeneity measures to classify reference-ability into separate divisions based on the different levels of homogeneity. From the tree illustrated in FIG. 4, it can be seen that the first level split is by recommend score. Any respondent with a value less than 6 on the recommend score have similar chances of being references. The other divisions on the first level are respondents who gave different values of the recommend score. This categorization is split further based on some of the branches, the branch with respondents who gave less than 6 is further divided based on satisfaction with product quality. Every respondent with a value less than or equal to 3 are in one category and the respondents who gave 4 and 5 are in another category based on the differences in reference-ability. Similarly node 3 is divided based on the satisfaction with time to implement. Every respondent with a value less than or equal to 3 are in one category and the respondents who gave 4 and 5 are in another category based on the differences in reference-ability.

Nonparametric tests are used to determine whether differences seen within the sample are actually significant to the entire population. The default hypothesis called the null hypothesis states that there is no evidence to prove differences between the segments of the population. When enough evidence to disprove the null hypothesis is obtained, it can be shown that the alternative hypothesis is true, which is that the segments of the population are actually different. A p value of 0.05 is used as the cut off to determine significance. When a p value is less than 0.05 it can be shown that the null hypothesis is false. A p value of less that 0.05 signifies that 95% of the time the difference between the segments in the population will be at least as significant as the difference between the segments in the sample. Nonparametric test is more efficient than the t-test as nonparametric test does not make the assumptions on normal distribution of the data. It is also referred as distribution-free tests. Nonparametric tests can be useful for dealing with unexpected, outlying observations. Nonparametric methods are intuitive and useful in the analysis of ordinal data. In case of continuous data T-tests are used to compare the significance level. Since most of the data may be categorical in nature, non-parametric tests are more accurate and more applicable.

The chi-square test is used to determine if the observed count in each cell differs from the expected count under the assumption of null hypothesis of no association. It's a method for testing the association between categorical variables. Chi-square test can be performed on nominal or ordinal data and thus uses frequencies instead of means and variances. Chi square test is based on following assumptions: Types of variable: The measures of two variables are either ordinal or nominal. The two variables should consist of two or more categorical groups. Sampling: Simple random sampling method is used for sampling. Each population is at least 10 times as large as its respective sample. The expected frequency count for each cell is at least 5. The chi-square test statistic is computed as X2=(Observed−Expected) 2/Expected Degree of freedom=(r−1) (c−1) Where, r=number of rows. c=number of columns. Chi-square test may be used in cross-tabulation to determine the significant difference in proportion. A significance level equal to 0.05 can be selected. Example: Is there a difference in proportion of references based on whether the project was on schedule or not? Reference is a binary variable which has values based on the response of the interviewee to the question whether he would like to be a reference or the product. The variable has 2 values of 0 and 1. 0 representing the interviewee has not agreed to be a reference and 1 representing that the interviewee has agreed to be a reference. OnSchedule is a categorical variable. OnSchedule has values based on the response to the question whether the project was on schedule. If the response is yes, OnSchedule will have a value of 1 and if the response is no the OnSchedule will have a value of 0. A cross tabulation between Reference and OnSchedule may be performed to display the relationship in a contingency table (Table 8).

TABLE 8
OnSchedule * Reference Cross-tabulation
Count

| | | Reference | | |
|---|---|---|---|---|
| | | Not a | | |
| | | Reference | Reference | Total |
| OnSchedule | Not on Schedule | 94 | 26 | 120 |
| | On Schedule | 63 | 51 | 114 |

| | | | |
|---|---|---|---|
| Total | 157 | 77 | 234 |

Chi-square test was performed on the variables to check for the association between them and based on the results of chi-square test, whether the observed frequencies differ significantly from the expected frequencies is determined.

TABLE 9
Chi-Square Tests

| | | | Asymp. | | |
|---|---|---|---|---|---|
| | | | Sig. | Exact Sig. | Exact Sig. |
| | Value | Df | (2-sided) | (2-sided) | (1-sided) |
| Pearson Chi-Square | 14.093^{a} | 1 | .000 | | |
| Continuity | 13.068 | 1 | .000 | | |
| Correction^{b} | | | | | |
| Likelihood Ratio | 14.273 | 1 | .000 | | |
| Fisher's Exact Test | | | | .000 | .000 |
| Linear-by-Linear | 14.033 | 1 | .000 | | |
| Association | | | | | |
| N of Valid Cases | 234 | | | | |

^{a}0 cells (0.0%) have expected count less than 5. The minimum expected count is 37.51.
^{b}Computed only for a 2 × 2 table

### Interpretation of Result in Table 9:

Since the P-value (0.000) is less than the significance level (0.05), the null hypothesis cannot be accepted. Thus, it is concluded that there is a relationship between Reference-ability and OnSchedule.

Kruskal-Wallis Analysis: In a nonparametric test Kruskal-Wallis analysis may be used. This test may be used for comparing means of two or more independent variables in relation to the variation in data. Kruskal-Wallis test is performed on ranked data. Kruskal-Wallis test assumes that within each sample the observations are independent and distributed identically. It also assumes that the samples are independent of each other. The Kruskal-Wallis statistic is computed a̅s̅KW=[12/N(N+1)]Σnᵢ(Rᵢ−(N+1)/2)² where, Rᵢ=Mean rank for the group i.nᵢ=number of the observation in group i..N=n₁+n₂+ . . . +n_{K}. For example, the differences between satisfaction variables may be viewed in terms of their project being OnSchedule. The satisfaction variables have ranked value with 1 as lowest and 5 as highest. OnSchedule is a categorical variable with minimum value 0 and maximum value 1.

TABLE 11
Ranks

| | OnSchedule | N | Mean Rank |
|---|---|---|---|
| Satisfaction with Product | Not on Schedule | 110 | 93.81 |
| Quality | On Schedule | 110 | 127.19 |
| | Total | 220 | |
| Satisfaction with Breadth | Not on Schedule | 100 | 94.58 |
| Of Features | On Schedule | 105 | 111.02 |
| | Total | 205 | |
| Satisfaction with Time to | Not on Schedule | 114 | 93.81 |
| Install | On Schedule | 108 | 130.17 |
| | Total | 222 | |
| Satisfaction with Time to | Not on Schedule | 95 | 74.30 |
| Implementation | On Schedule | 88 | 111.11 |
| | Total | 183 | |
| Satisfaction with Ease of | Not on Schedule | 103 | 91.18 |
| Use | On Schedule | 106 | 118.42 |
| | Total | 209 | |

TABLE 12
Test Statistics^{a,b}

| | Satisfaction | Satisfaction | Satisfaction | Satisfaction | Satisfaction |
|---|---|---|---|---|---|
| | with Product | with Breadth | with Time to | with Time to | with Ease of |
| | Quality | Of Features | Install | Implementation | Use |
| Chi-Square | 18.436 | 4.817 | 19.307 | 24.504 | 12.597 |
| Df | 1 | 1 | 1 | 1 | 1 |
| Asymp. | .000 | .028 | .000 | .000 | .000 |
| Sig. | | | | | |

^{a}Kruskal Wallis Test
^{b}Grouping Variable: OnSchedule

### Interpretation of the Result:

The rank table (Table 11) shows the mean rank of each satisfaction variable for whether or not they were OnSchedule. The test statistic table (Table 12) gives the significance level. Since P value for each satisfaction variable is less than the significance level (0.05), the null hypothesis cannot be accepted. Thus, it can be concluded that there is evidence to show that the differences in proportion of satisfaction variables are statistically significant.

It can be appreciated that the method 100 or similar method for a software vendor proactively identifying problems a customer may have with software procured from the software vendor (or system for implementing the method 100 or similar method) may be implemented as a service (paid or otherwise) in a cloud computing environment as discussed in the following paragraphs.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

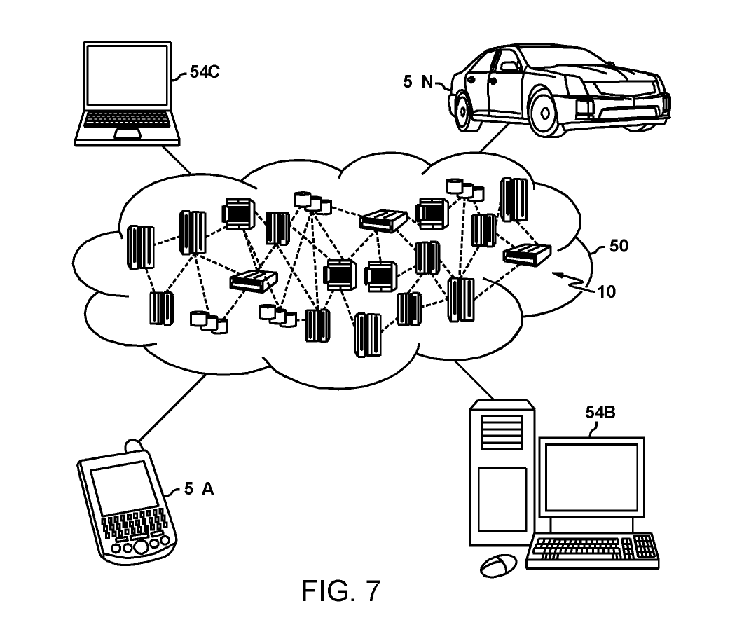

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

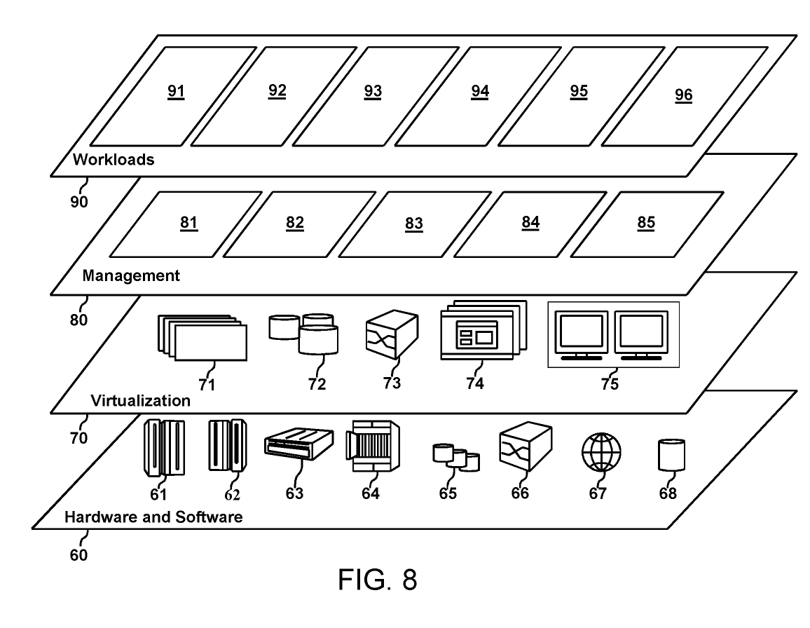

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a service 96 for a software vendor proactively identifying problems a customer may have with software procured from the software vendor (e.g., service for implementing the method 100 or similar method).

Technical effects and benefits include identifying problems or potential problems customers may have with software purchased from the software vendor trying to identify the problems or potential problems. By identifying the problems or potential problems, a remedial plan may be implemented to correct the identified problems or prevent the identified potential problems.

Set forth below are some embodiments of the foregoing disclosure:

### Embodiment 1

A method for a software vendor to proactively identify problems a customer may have with software procured from the software vendor, the method comprising: inputting into a data set, by a processor, customer data having customer identifying data and customer-satisfaction data related to customer satisfaction with the software; constructing, by the processor, a mathematical model that is configured to model first quantitative customer-satisfaction attributes in the customer-satisfaction data; applying, by the processor, one or more robustness analytic processes to the mathematical model to determine a robustness value that quantifies robustness of the mathematical model; determining, by the processor, if the robustness value of the mathematical model meets or exceeds a robustness threshold value; applying, by the processor, one or more significance analytic processes to the modeled first quantitative customer-satisfaction attributes to determine a significance value that quantifies statistical significance of the quantified customer-satisfaction attributes in response to the robustness value of the mathematical model meeting or exceeding a robustness threshold value; sending, by the processor, a notification comprising the quantified customer-satisfaction attributes to a subject matter expert in response to the significance value being less than or equal to a significance threshold value and the quantified customer-satisfaction attributes express dissatisfaction with the software; receiving, by the processor, from the subject matter expert a remedial plan to improve the quantified customer-satisfaction attributes; and implementing, by the processor, the remedial plan by implementing at least one selection from the group consisting of modifying the software to provide modified software, modifying a configuration of the software to provide a modified configuration, and modifying an implementation plan for implementing the software to provide a modified implementation plan.

### Embodiment 2

The method according to claim 1, further comprising: providing, by the processor, the modified software, the modified configuration, and/or the modified implementation plan to the customer; inputting, by the processor, into the data set feedback solicited from the customer related to the modified software, the modified configuration, and/or the modified implementation plan, the feedback comprising second quantitative customer-satisfaction attributes; iterating, by the processor, the inputting, the constructing, the applying one or more robustness analytic processes, the determining, and the applying one or more significance analytic processes using the second quantitative customer-satisfaction attributes and determining if the significance value related to the second quantitative customer-satisfaction attributes is less than or equal to the significance threshold value and the second quantitative customer-satisfaction attributes express satisfaction or if the significance value related to the second quantitative customer-satisfaction attributes is less than or equal to the significance threshold value and the second quantitative customer-satisfaction attributes express dissatisfaction; repeating, by the processor, the sending, the receiving, the implementing, the providing, the soliciting, and the iterating in response to the significance value related to the second quantitative customer-satisfaction attributes being less than or equal to the significance threshold value and the second quantitative customer-satisfaction attributes express dissatisfaction; and ending, by the processor, the method in response to the significance value related to the second quantitative customer-satisfaction attributes being less than or equal to the significance threshold value and the second quantitative customer-satisfaction attributes express satisfaction.

### Embodiment 3

The method according to claim 1, wherein implementing comprises at least one selection from the group consisting of writing the modified software on a non-transitory computer-readable medium using a software writing device, writing the modified configuration on a non-transitory computer-readable medium using a software writing device, and writing the modified implementation plan on a non-transitory computer-readable medium using a software writing device.

### Embodiment 4

The method according to claim 1, wherein ending comprises proactively stopping the remedial plan or portion of remedial plan from being implemented further.

### Embodiment 5

The method according to claim 4, wherein ending further comprises sending a notification that the second quantitative customer-satisfaction attributes express satisfaction to a user or to the data set for entry using the processor.

### Embodiment 6

The method according to claim 1, wherein inputting comprises conducting an interview with the customer in order to obtain the customer-satisfaction data related to customer satisfaction with the software, the interview comprising a plurality of questions.

### Embodiment 7

The method according to claim 6, further comprising quantifying answers to the plurality of interview questions using numeric values.

### Embodiment 8

The method according to claim 1, wherein the subject matter expert comprises an expert system implemented by a processor.

### Embodiment 9

The method according to claim 1, wherein the robustness analytic processes comprise at least one selection from the group consisting of multiple linear regression, logistic regression, ordinal regression, a decision tree, a nonparametric test, a chi-square test, a Kruskal-Wallis test, cluster analysis, discriminant analysis, and a neural network.

### Embodiment 10

The method according to claim 1, wherein the significance analytic processes comprise at least one selection from the group consisting of multiple linear regression, logistic regression, ordinal regression, a decision tree, a nonparametric test, a chi-square test, a Kruskal-Wallis test, cluster analysis, discriminant analysis, and a neural network

### Embodiment 11

The method according to claim 1, wherein the method is implemented in a cloud computing environment.

### Embodiment 12

A system for a software vendor proactively identifying problems a customer may have with software procured from the software vendor, the system comprising: a memory having computer readable instructions; and a processor for executing the computer readable instructions, the computer readable instructions comprising: inputting into a data set customer data having customer identifying data and customer-satisfaction data related to customer satisfaction with the software; constructing a mathematical model that is configured to model first quantitative customer-satisfaction attributes in the customer-satisfaction data; applying one or more robustness analytic processes to the mathematical model to determine a robustness value that quantifies robustness of the mathematical model; determining if the robustness value of the mathematical model meets or exceeds a robustness threshold value; applying one or more significance analytic processes to the modeled first quantitative customer-satisfaction attributes to determine a significance value that quantifies statistical significance of the quantified customer-satisfaction attributes in response to the robustness value of the mathematical model meeting or exceeding a robustness threshold value; sending a notification comprising the quantified customer-satisfaction attributes to a subject matter expert in response to the significance value meeting or exceeding a significance threshold value and the quantified customer-satisfaction attributes express dissatisfaction with the software; receiving from the subject matter expert a remedial plan to improve the quantified customer-satisfaction attributes; and implementing the remedial plan by implementing at least one selection from the group consisting of modifying the software to provide modified software, modifying a configuration of the software to provide a modified configuration, and modifying an implementation plan for implementing the software to provide a modified implementation plan.

### Embodiment 13

The system according to claim 12, wherein the computer readable instructions further comprise: providing the modified software, the modified configuration, and/or the modified implementation plan to the customer; soliciting feedback from the customer related to the modified software, the modified configuration, and/or the modified implementation plan, the feedback comprising second quantitative customer-satisfaction attributes; iterating the inputting, the constructing, the applying one or more robustness analytic processes, the determining, and the applying one or more significance analytic processes using the second quantitative customer-satisfaction attributes and determining if the significance value related to the second quantitative customer-satisfaction attributes is less than or equal to the significance threshold value and the second quantitative customer-satisfaction attributes express satisfaction or if the significance value related to the second quantitative customer-satisfaction attributes is less than or equal to the significance threshold value and the second quantitative customer-satisfaction attributes express dissatisfaction; repeating the sending, the receiving, the implementing, the providing, the soliciting, and the iterating in response to the significance value related to the second quantitative customer-satisfaction attributes being less than or equal to the significance threshold value and the second quantitative customer-satisfaction attributes express dissatisfaction; and ending the method in response to the significance value related to the second quantitative customer-satisfaction attributes being less than or equal to the significance threshold value and the second quantitative customer-satisfaction attributes express satisfaction.

### Embodiment 14

The system according to claim 12, wherein implementing comprises at least one of writing the modified software, the modified configuration, and the modified implementation plan on a non-transitory computer-readable medium using a software writing device.

### Embodiment 15

The system according to claim 12, wherein ending comprises proactively stopping the remedial plan or portion of remedial plan from being implemented further.

### Embodiment 16

The system according to claim 12, wherein inputting comprises conducting an interview with the customer in order to obtain the customer-satisfaction data related to customer satisfaction with the software, the interview comprising a plurality of interview questions.

### Embodiment 17

The system according to claim 16, wherein the computer readable instructions further comprise quantifying answers to the plurality of interview questions using numeric values.

### Embodiment 18

The system according to claim 12, wherein the subject matter expert comprises an expert system implemented by a processor.

### Embodiment 19

The system according to claim 12, wherein the system is part of a cloud computing environment.

### Embodiment 20

A computer program product for a software vendor proactively identifying problems a customer may have with software procured from the software vendor, the computer program product comprising a computer readable storage medium having program instructions embodied therewith, the program instructions executable by a processor to cause the processor to: input into a data set customer data having customer identifying data and customer-satisfaction data related to customer satisfaction with the software; construct a mathematical model that is configured to model first quantitative customer-satisfaction attributes in the customer-satisfaction data; apply one or more robustness analytic processes to the mathematical model to determine a robustness value that quantifies robustness of the mathematical model; determine if the robustness value of the mathematical model meets or exceeds a robustness threshold value; apply one or more significance analytic processes to the modeled first quantitative customer-satisfaction attributes to determine a significance value that quantifies statistical significance of the quantified customer-satisfaction attributes using the processor in response to the robustness value of the mathematical model meeting or exceeding a robustness threshold value; send a notification comprising the quantified customer-satisfaction attributes to a subject matter expert in response to the significance value being less than or equal to a significance threshold value and the quantified customer-satisfaction attributes express dissatisfaction with the software; receive from the subject matter expert a remedial plan to improve the quantified customer-satisfaction attributes; and implement the remedial plan by implementing at least one selection from the group consisting of modifying the software to provide modified software, modifying a configuration of the software to provide a modified configuration, and modifying an implementation plan for implementing the software to provide a modified implementation plan.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “configured” relates to one or more structural limitations of a device that are required for the device to perform the function or operation for which the device is configured.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for a software vendor to proactively identify problems a customer may have with software procured from the software vendor, the method comprising:
inputting into a data set, by a processor, customer data having customer identifying data and customer-satisfaction data related to customer satisfaction with the software;
constructing, by the processor, a mathematical model that is configured to model first quantitative customer-satisfaction attributes in the customer-satisfaction data;
applying, by the processor, one or more robustness analytic processes to the mathematical model to determine a robustness value that quantifies robustness of the mathematical model;
determining, by the processor, if the robustness value of the mathematical model meets or exceeds a robustness threshold value;
applying, by the processor, one or more significance analytic processes to the modeled first quantitative customer-satisfaction attributes to determine a significance value that quantifies statistical significance of the quantified customer-satisfaction attributes in response to the robustness value of the mathematical model meeting or exceeding a robustness threshold value;
sending, by the processor, a notification comprising the quantified customer-satisfaction attributes to a subject matter expert in response to the significance value being less than or equal to a significance threshold value and the quantified customer-satisfaction attributes express dissatisfaction with the software;
receiving, by the processor, from the subject matter expert a remedial plan to improve the quantified customer-satisfaction attributes; and
implementing, by the processor, the remedial plan by implementing at least one selection from the group consisting of modifying the software to provide modified software, modifying a configuration of the software to provide a modified configuration, and modifying an implementation plan for implementing the software to provide a modified implementation plan.

2. The method according to claim 1, further comprising:
providing, by the processor, the modified software, the modified configuration, and/or the modified implementation plan to the customer;
inputting, by the processor, into the data set feedback solicited from the customer related to the modified software, the modified configuration, and/or the modified implementation plan, the feedback comprising second quantitative customer-satisfaction attributes;
iterating, by the processor, the inputting, the constructing, the applying one or more robustness analytic processes, the determining, and the applying one or more significance analytic processes using the second quantitative customer-satisfaction attributes and determining if the significance value related to the second quantitative customer-satisfaction attributes is less than or equal to the significance threshold value and the second quantitative customer-satisfaction attributes express satisfaction or if the significance value related to the second quantitative customer-satisfaction attributes is less than or equal to the significance threshold value and the second quantitative customer-satisfaction attributes express dissatisfaction;
repeating, by the processor, the sending, the receiving, the implementing, the providing, the soliciting, and the iterating in response to the significance value related to the second quantitative customer-satisfaction attributes being less than or equal to the significance threshold value and the second quantitative customer-satisfaction attributes express dissatisfaction; and
ending, by the processor, the method in response to the significance value related to the second quantitative customer-satisfaction attributes being less than or equal to the significance threshold value and the second quantitative customer-satisfaction attributes express satisfaction.

3. The method according to claim 1, wherein implementing comprises at least one selection from the group consisting of writing the modified software on a non-transitory computer-readable medium using a software writing device, writing the modified configuration on a non-transitory computer-readable medium using a software writing device, and writing the modified implementation plan on a non-transitory computer-readable medium using a software writing device.

4. The method according to claim 1, wherein ending comprises proactively stopping the remedial plan or portion of remedial plan from being implemented further.

5. The method according to claim 4, wherein ending further comprises sending a notification that the second quantitative customer-satisfaction attributes express satisfaction to a user or to the data set for entry using the processor.

6. The method according to claim 1, wherein inputting comprises conducting an interview with the customer in order to obtain the customer-satisfaction data related to customer satisfaction with the software, the interview comprising a plurality of questions.

7. The method according to claim 6, further comprising quantifying answers to the plurality of interview questions using numeric values.

8. The method according to claim 1, wherein the subject matter expert comprises an expert system implemented by a processor.

9. The method according to claim 1, wherein the robustness analytic processes comprise at least one selection from the group consisting of multiple linear regression, logistic regression, ordinal regression, a decision tree, a nonparametric test, a chi-square test, a Kruskal-Wallis test, cluster analysis, discriminant analysis, and a neural network.

10. The method according to claim 1, wherein the significance analytic processes comprise at least one selection from the group consisting of multiple linear regression, logistic regression, ordinal regression, a decision tree, a nonparametric test, a chi-square test, a Kruskal-Wallis test, cluster analysis, discriminant analysis, and a neural network.

11. The method according to claim 1, wherein the method is implemented in a cloud computing environment.
